(19) United States
(12) Patent Application Publication
(10) Pub. No.: US 2016/0036185 A1
(43) Pub. Date: Feb. 4, 2016

(54) APPARATUS AND METHODS FOR CLEANING ELECTRICAL CONTACTS

(71) Applicants: Ian R. Vinci, Shandaken, NY (US); Peter Vinci, Shandaken, NY (US)

(72) Inventors: Ian R. Vinci, Shandaken, NY (US); Peter Vinci, Shandaken, NY (US)

(21) Appl. No.: 14/450,657

(22) Filed: Aug. 4, 2014

(51) Int. Cl. H01R 43/00; B08B 1/00

(52) U.S. Cl. CPC H01R 43/002; B08B 1/006

(57) ABSTRACT

Aspects of the invention are directed to an apparatus comprising a first arm and a second arm. The first arm defines a first proximal end region and a first distal end region. The first distal end region defines a first partial hollow cylinder with a first inner face and a first outer face. The second arm defines a second proximal end region and a second distal end region. The second proximal end region is fixated to the first proximal end region. The second distal end region defines a second partial hollow cylinder with a second inner face and a second outer face. Each of the first inner face, the first outer face, the second inner face, and the second outer face are at least partially coated in an abrasive material.

### FIELD OF THE INVENTION

The present invention relates generally to electrical connectors, and, more particularly, to apparatus and methods for cleaning electrical contacts.

### BACKGROUND OF THE INVENTION

Electrical connectors may provide temporary or permanent interfaces in electrical circuits. At the time of this writing, there are literally hundreds of types of electrical connectors. Many common electrical connectors, for example, utilize round male pin contacts and corresponding cylindrical female socket contacts to form manually disconnectable electrical connections. The contacts are installed in respective housings (e.g., jacks or plugs) that are themselves often mechanically joinable.

Electrical connectors of the type described above are frequently exposed to harsh environments. For example, those connectors utilized to form electrical circuits between the electrical systems of trailers and tow-vehicles are frequently positioned near the road, and are therefore exposed to large amounts of dirt and moisture. Dirt can coat the electrical contacts, forming a high-resistance surface layer. Moisture, especially when combined with road salt, can corrode the electrical contacts. Ultimately, this dirt and/or corrosion can cause a trailer to no longer function properly and create an unsafe driving condition.

For the foregoing reasons, there is a need for low-cost apparatus that make it easy and convenient to clean dirt and corrosion from electrical contacts such as round male pin contacts and cylindrical female socket contacts so that these electrical contacts are capable of reliably forming and maintaining low-resistance electrical connections.

### SUMMARY OF THE INVENTION

Embodiments of the present invention address the above-identified needs by providing an apparatus for cleaning round male pin contacts and cylindrical female socket contacts. Advantageously, a single apparatus is operative to clean both types of contacts.

Aspects of the invention are directed to an apparatus comprising a first arm and a second arm. The first arm defines a first proximal end region and a first distal end region. The first distal end region defines a first partial hollow cylinder with a first inner face and a first outer face. The second arm defines a second proximal end region and a second distal end region. The second proximal end region is fixated to the first proximal end region. The second distal end region defines a second partial hollow cylinder with a second inner face and a second outer face. Each of the first inner face, the first outer face, the second inner face, and the second outer face are at least partially coated in an abrasive material.

Additional aspects of the invention are directed to a method for cleaning a cylindrical female socket contact. An apparatus is received. The apparatus comprises a first arm and a second arm. The first arm defines a first proximal end region and a first distal end region. The first distal end region defines a first partial hollow cylinder with a first inner face and a first outer face. The second arm defines a second proximal end region and a second distal end region. The second proximal end region is fixated to the first proximal end region. The second distal end region defines a second partial hollow cylinder with a second inner face and a second outer face. Each of the first inner face, the first outer face, the second inner face, and the second outer face are at least partially coated in an abrasive material. To clean the cylindrical female socket contact, at least a portion of the first distal end region and the second distal end region are inserted into the cylindrical female socket contact. The apparatus is then translated and/or rotated such that the first outer face and the second outer face rub against an inner surface of the cylindrical female socket contact.

Even additional aspects of the invention are directed to a method for cleaning a round male pin contact. An apparatus is received. The apparatus comprises a first arm and a second arm. The first arm defines a first proximal end region and a first distal end region. The first distal end region defines a first partial hollow cylinder with a first inner face and a first outer face. The second arm defines a second proximal end region and a second distal end region. The second proximal end region is fixated to the first proximal end region. The second distal end region defines a second partial hollow cylinder with a second inner face and a second outer face. Each of the first inner face, the first outer face, the second inner face, and the second outer face are at least partially coated in an abrasive material. To clean the round male pin contact, at least a portion of the round male pin contact is encircled by the first distal end region and the second distal end region. The apparatus is then translated and/or rotated such that the first inner face and the second inner face rub against an outer surface of the round male pin contact.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of an apparatus in accordance with an illustrative embodiment of the invention;

FIG. 2 shows a magnified perspective view of a portion of the FIG. 1 apparatus in a relaxed state;

FIG. 3 shows a magnified perspective view of a portion of the FIG. 1 apparatus in a pressed state;

FIG. 4 shows an elevational view of a portion of the FIG. 1 apparatus with several dimensions labeled by reference letters;

FIG. 5 shows a perspective view of a user preparing to utilize the FIG. 1 apparatus to clean a cylindrical female socket contact;

FIG. 6 shows a perspective view of a portion of the FIG. 1 apparatus and a cylindrical female socket contact with a portion of the apparatus inserted into the cylindrical female socket contact;

FIG. 7 shows a sectional view of a portion of the FIG. 1 apparatus and a cylindrical female socket contact along the plane indicated in FIG. 6;

FIG. 8 shows a perspective view of a user preparing to utilize the FIG. 1 apparatus to clean a round male pin contact;

FIG. 9 shows a perspective view of a portion of the FIG. 1 apparatus and a round male pin contact with a portion of the apparatus encircling the round male pin contact; and

FIG. 10 shows a sectional view of a portion of the FIG. 1 apparatus and a round male pin contact along the plane indicated in FIG. 9.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

As used herein, the phrase “manually configurable” into a given state is intended to mean being capable of being configured into that given state by a person having ordinary strength using only that person's hands and without tools.

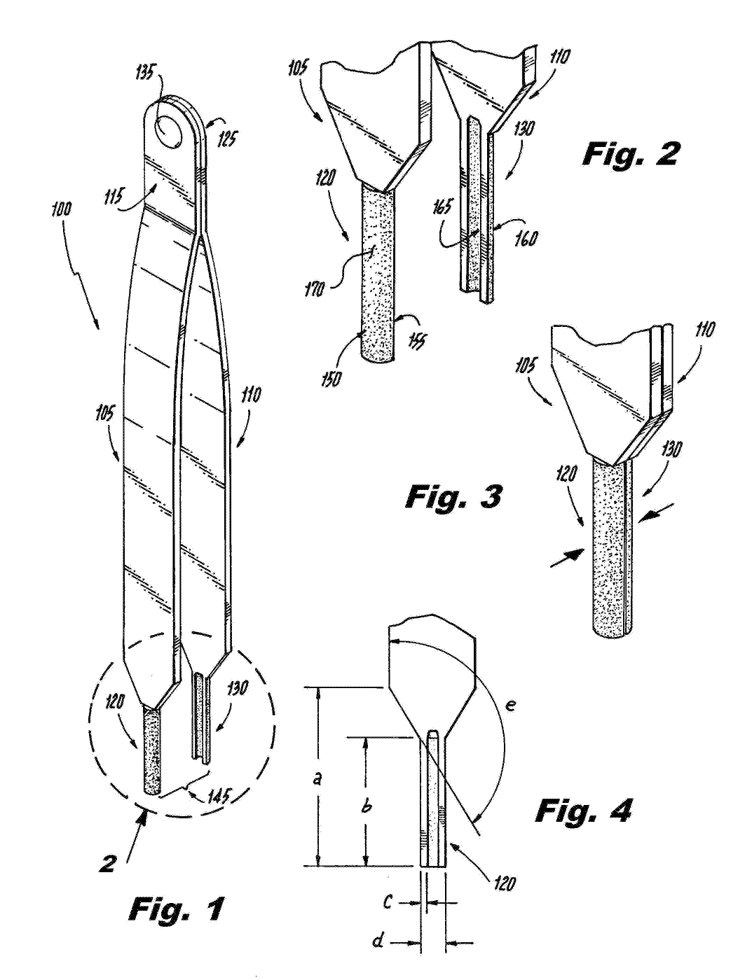

FIG. 1 shows a perspective view of an apparatus 100 in accordance with an illustrative embodiment of the invention. The apparatus 100 comprises a first arm 105 and a second arm 110. The first arm 105 defines a first proximal end region 115 and a first distal end region 120, while the second arm 110 defines a second proximal end region 125 and a second distal end region 130. The first proximal end region 115 is pressed against the second proximal end region 125, and is fastened thereto by a fastener 135. Just below the first and second proximal end regions 115, 125 (as the apparatus 100 is oriented in FIG. 1), the first arm 105 and the second arm 110 diverge from each other.

This configuration allows the apparatus 100 to take on two different states: a relaxed state and a pressed state. FIG. 2 shows a magnified perspective view of the first distal end region 120 and the second distal end region 130 with the apparatus 100 in the relaxed state, while FIG. 3 shows a magnified perspective view of the same elements with the apparatus 100 in its pressed state. The relaxed state (FIG. 2) occurs when no external forces are placed on the apparatus 100. In this state, the first and second distal end regions 120, 130 define a gap 145 therebetween. The apparatus 100 may be manually configured into the pressed state (FIG. 3) by pressing the first arm 105 and the second arm 110 towards each other (arrows). The pressed state is characterized by the first distal end region 120 being in contact with the second distal end region 130. In the pressed state, the first arm 105 and the second arm 110 are resilient away from each other. This means that the two arms 105, 110 will tend to part so that the apparatus 100 returns to the relaxed state if the manual pressing force is removed and nothing else is holding the two distal end regions 120, 130 together.

The first and second distal end regions 120, 130 of the apparatus 100 define unique structures. More particularly, the first distal end region 120 defines a first partial hollow cylinder, while the second distal end region 130 defines a second partial hollow cylinder (FIG. 2). Each of the first and second distal end regions 120, 130 therefore has two respective faces. The first distal end region 120 defines a first outer face 150 and a first inner face 155, while the second distal end region 130 defines a second outer face 160 and a second inner face 165 (FIG. 2). In the present illustrative embodiment, each of the first outer face 150, the first inner face 155, the second outer face 160, and the second inner face 165 are at least partially coated in an abrasive material 170. When pressed together, the first distal end region 120 and the second distal end region 130 combine to form a complete hollow cylinder (FIG. 3).

As further detailed below, the apparatus 100 may be utilized to clean both round male pin contacts and cylindrical female socket contacts. To facilitate this kind of use, the apparatus 100 may be formed in sizes that accommodate common dimensions for these types of contacts. FIG. 4 shows an elevational view of the first distal end region 120 of the apparatus 100 with several dimensions labeled by reference letters. Table I, in turn, shows illustrative dimensions corresponding to these reference letters for three different sizes of apparatus 100: small, medium, and large. It is emphasized, however, that these dimensions are merely by way of illustration only, and should not be construed to limit the scope of the invention.

TABLE I
Illustrative dimensions corresponding to reference letters in FIG. 4
for three different sizes of the apparatus 100.

| Apparatus | | | | | |
|---|---|---|---|---|---|
| Size | a (inches) | b (inches) | c (inches) | d (inches) | e (degrees) |
| Small | 0.704 | 0.500 | 0.025 | 0.090 | 149 |
| Medium | 0.576 | 0.500 | 0.030 | 0.120 | 130 |
| Large | 0.587 | 0.500 | 0.030 | 0.150 | 133 |

Once understood from the teachings herein, the apparatus 100 may be formed from conventional materials utilizing conventional manufacturing techniques. In one or more embodiments, for example, the first and second arms 105, 110 may comprise a metal such as spring steel, and the fastener 135 may comprise a fastener such as a rivet, a pin, a bolt, or a screw. In even one or more alternative embodiments, moreover, the first arm 105 may be fixated to the second arm 110 by welding or adhesion, foregoing the need for the fastener 135. The abrasive material 170 on the first and second arms 105, 110 may comprise a coarse material such as diamond, aluminum oxide, tungsten carbide, and silicon carbide. The abrasive material 170 may be attached to the rest of the apparatus 100 by an adhesive (not shown).

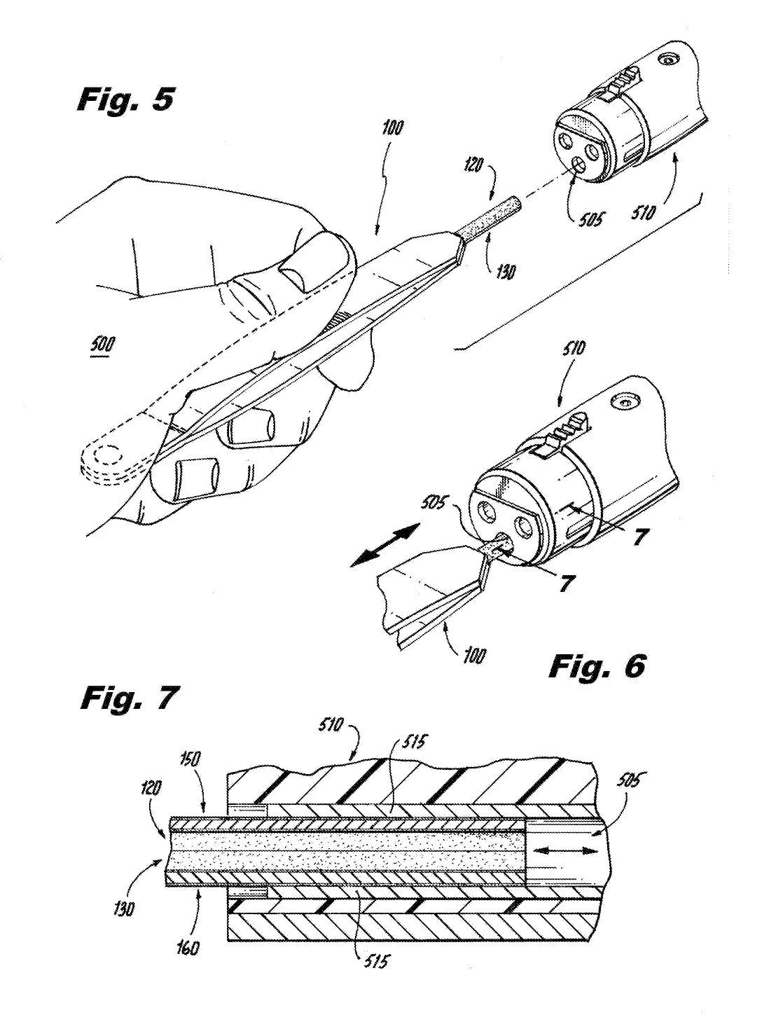

FIGS. 5-7 illustrate how the apparatus 100 may be utilized to clean cylindrical female socket contacts, in accordance with an illustrative embodiment of the invention. More particularly, FIG. 5 shows a perspective view of a user 500 preparing to insert the first and second distal end regions 120, 130 of the apparatus 100 into a cylindrical female socket contact 505 of a plug 510, while FIG. 6 shows the first and second distal end regions 120, 130 inserted into the cylindrical female socket contact 505. Finally, FIG. 7 shows a sectional view of the first and second distal end regions 120, 130 of the apparatus 100 and the cylindrical female socket contact 505 along the plane indicated in FIG. 6.

To clean the cylindrical female socket contact 505, the user 500 initially presses the first arm 105 towards the second arm 110 to cause the apparatus 100 to take on its pressed state (FIG. 5). In the pressed state, the hollow cylinder formed by the combination of the first and second distal end regions 120, 130 preferably has a outer diameter about equal to the inner diameter of the cylindrical female socket contact 505. The user 500 then inserts the first and second distal end regions 120, 130 into the cylindrical female socket contact (FIG. 6). Once so inserted, the first and second outside faces 150, 160 of the first and second distal end regions 120, 130 (coated in the abrasive material 170), respectively, make contact with the surface of an electrode 515 of the cylindrical female socket contact 505. The user 500 may then translate the first and second distal end regions 120, 130 back and forth along the longitudinal axis of the cylindrical female socket contact 505 to cause the first and second outer faces 150, 160 to “scrub” the electrode 515. Alternatively or additionally, the user 500 may twist the apparatus 100 about the same longitudinal axis to provide the scrubbing motion.

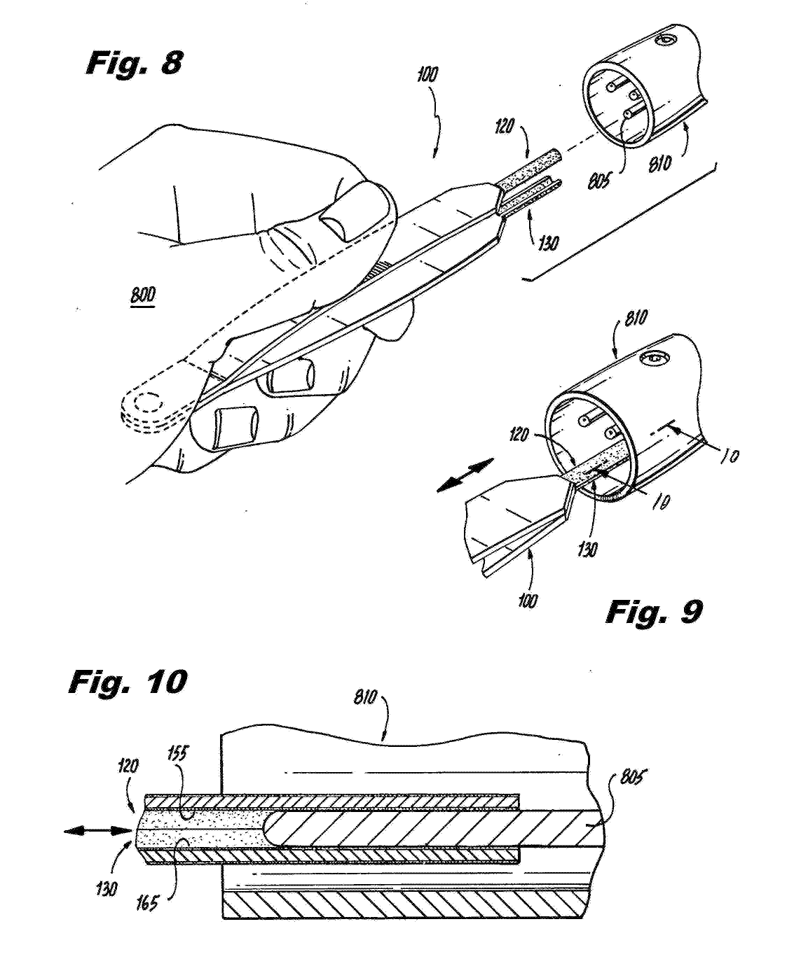

FIGS. 8-10 illustrate how the apparatus 100 may also be utilized to clean round male pin contacts, in accordance with an illustrative embodiment of the invention. FIG. 8 shows a perspective view of a user 800 preparing to wrap the first and second distal end regions 120, 130 of the apparatus 100 around a round male pin contact 805 of a jack 810, while FIG. 6 shows the first and second distal end regions 120, 130 encircling the round male pin contact 805. Finally, FIG. 10 shows a sectional view of the first and second distal end regions 120, 130 and the round male pin contact 805 along the plane indicated in FIG. 9.

To clean the round male pin contact 805, the user 800 initially allows the apparatus 100 to take on its relaxed state (FIG. 8). The user 800 then brings the first distal end region 120 and the second distal end region 130 together around the round male pin contact 805 by pressing the first arm 105 towards the second arm 110 (FIG. 9). The resultant hollow cylinder formed by the combination of the first and second distal end regions 120, 130 preferably has an inner diameter about equal to the outer diameter of the round male pin contact 805. Once encircling the round male pin contact 805, the first and second inner faces 155, 165 of the first and second distal end regions 120, 130 (coated in the abrasive material 170), respectively, make contact with the outside surface of the round male pin contact 805. The user 800 may then translate the first and second distal end regions 120, 130 back and forth along the longitudinal axis of the round male pin contact 805to cause the first and second inner faces 155, 165 to scrub the round male pin contact 805. Alternatively or additionally, the user 800 may scrub the round male pin contact 805 by providing a twisting motion to the apparatus 100.

Accordingly, as described above with reference to FIGS. 5-10, the single apparatus 100 has the advantage of being operative to effectively clean both cylindrical female socket contacts and round male pin contacts by abrasion. A user is therefore not tasked with acquiring and storing different tooling when cleaning each type of electrical contact.

It should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. An apparatus comprising:
a first arm, the first arm defining a first proximal end region and a first distal end region, the first distal end region defining a first partial hollow cylinder with a first inner face and a first outer face; and
a second arm, the second arm defining a second proximal end region and a second distal end region, the second proximal end region fixated to the first proximal end region, and the second distal end region defining a second partial hollow cylinder with a second inner face and a second outer face;
wherein each of the first inner face, the first outer face, the second inner face, and the second outer face are at least partially coated in an abrasive material.

2. The apparatus of claim 1, wherein the first distal end region and the second distal end region define a gap therebetween when no external forces are applied to the apparatus.

3. The apparatus of claim 1, wherein the apparatus is manually configurable into a pressed state by pressing the first arm and the second arm towards each other, the pressed state characterized by the first distal end region being in contact with the second distal end region.

4. The apparatus of claim 3, wherein a portion of the first arm and a portion of the second arm are resilient in a direction away from each other when the apparatus is in the pressed state.

5. The apparatus of claim 3, wherein the first distal end region and the second distal end region combine to define a hollow cylinder when the apparatus is in the pressed state.

6. The apparatus of claim 1, wherein the apparatus comprises steel.

7. The apparatus of claim 1, further comprising a fastener, the fastener passing through the first proximal end region and the second proximal end region.

8. The apparatus of claim 7, wherein the fastener comprises a rivet, a pin, a bolt, or a screw.

9. The apparatus of claim 1, wherein the abrasive comprises at least one of diamond, aluminum oxide, tungsten carbide, and silicon carbide.

10. The apparatus of claim 1, wherein the apparatus is adapted so that the first distal end region and the second distal end region can be made to encircle a round male pin contact such that the first inner face and the second inner face come into contact with an outside surface of the round male pin contact.

11. The apparatus of claim 1, wherein the apparatus is adapted so that at least a portion of the first distal end region and at least a portion of the second distal end region can be inserted into a cylindrical female socket contact such that the first outer face and the second outer face come into contact with an inside surface of the cylindrical female socket contact.

12. A method for cleaning a cylindrical female socket contact, the method comprising the steps of:
receiving an apparatus, the apparatus comprising:
a first arm, the first arm defining a first proximal end region and a first distal end region, the first distal end region defining a first partial hollow cylinder with a first inner face and a first outer face;
a second arm, the second arm defining a second proximal end region and a second distal end region, the second proximal end region fixated to the first proximal end region, and the second distal end region defining a second partial hollow cylinder with a second inner face and a second outer face;
wherein each of the first inner face, the first outer face, the second inner face, and the second outer face are at least partially coated in an abrasive material;
inserting at least a portion of the first distal end region and the second distal end region into the cylindrical female socket contact; and
translating and/or rotating the apparatus such that the first outer face and the second outer face rub against an inner surface of the cylindrical female socket contact.

13. A method for cleaning a round male pin contact, the method comprising the steps of:
receiving an apparatus, the apparatus comprising:
a first arm, the first arm defining a first proximal end region and a first distal end region, the first distal end region defining a first partial hollow cylinder with a first inner face and a first outer face;
a second arm, the second arm defining a second proximal end region and a second distal end region, the second proximal end region fixated to the first proximal end region, and the second distal end region defining a second partial hollow cylinder with a second inner face and a second outer face;
wherein each of the first inner face, the first outer face, the second inner face, and the second outer face are at least partially coated in an abrasive material;
encircling at least a portion of the round male pin contact with the first distal end region and the second distal end region; and
translating and/or rotating the apparatus such that the first inner face and the second inner face rub against an outer surface of the round male pin contact.
